(19) United States
(12) Patent Application Publication
(10) Pub. No.: US 2025/0250825 A1
(43) Pub. Date: Aug. 7, 2025

(54) CLOSURE LATCH ASSEMBLY WITH POWER RELEASE MECHANISM HAVING NOISE REDUCTION ARRANGEMENT

(71) Applicant: MAGNA CLOSURES INC., Newmarket (CA)

(72) Inventor: Dunia SARDELLI, Newmarket (CA)

(21) Appl. No.: 19/044,773

(22) Filed: Feb. 4, 2025

Related U.S. Application Data
(60) Provisional application No. 63/549,619, filed on Feb. 5, 2024.

(51) Int. Cl. E05B 81/14; E05B 81/06; E05B 81/30; E05B 81/36; F16H 19/08

(52) U.S. Cl. CPC E05B 81/14; E05B 81/06; E05B 81/30; E05B 81/36; F16H 19/08

(57) ABSTRACT

A power latch assembly has a ratchet moveable between a striker capture position and a striker release position and a pawl moveable between a ratchet holding position to maintain ratchet in the striker capture position, and a ratchet releasing position to release ratchet to the striker release position. A power actuator drives a power release gear having a rib. A spring is coupled to power release gear, a first lever is coupled to power release gear, and a second lever is coupled to pawl. Spring biases first lever to a rest position spaced from rib. Power actuator drives power release gear from a home position to a deployed position, whereupon first lever engages second lever and deflects against the spring bias from the rest position to engage rib, whereupon rib drives first lever, which drives second lever to move pawl from the ratchet holding position to the ratchet releasing position.

### CROSS-REFERENCE TO RELATED APPLICATION

This application claims the benefit of U.S. Provisional Application Ser. No. 63/549,619, filed Feb. 5, 2024, which is incorporated herein by way of reference in its entirety.

### FIELD

The present disclosure relates generally to automotive door latches, and more particularly, to a power door latch assembly equipped with a power release motor configured to drive a gear reduction having a spring biased noise reduction mechanism.

### BACKGROUND

This section provides background information related to automotive door latches and is not necessarily prior art to the concepts associated with the present disclosure.

A vehicle closure panel, such as a side door for a vehicle passenger compartment, for example only, is hinged to swing between open and closed positions and includes a latch assembly mounted to the door. The latch assembly functions in a well-known manner to latch the door when it is closed and unlatch and release the door to permit subsequent movement of the door to its open position. As is also well-known, the latch assembly is configured to include a latch mechanism for latching the door and a release mechanism for unlatching the door. The release mechanism can be power-operated to unlatch the door.

During powered actuation of latch mechanism, it is known to actuate a gear mechanism to move a pawl from a ratchet holding position to a ratchet releasing position, thereby allowing a ratchet to move from a striker capture position to a striker releasing position, whereat the door can be moved from a closed position to an open position. In order to ensure the pawl is able to be moved from the ratchet holding position to the ratchet releasing position, the motor must be provided having a sufficient output force to overcome any friction build-up between the pawl and the ratchet. In some cases, high seal loads are present between the door and the vehicle body, such as in an accident scenario, for example. In other cases, ice may increase the release force needed to move the pawl to the ratchet releasing position. As such, it is known that high friction loads are commonly present between interacting components, such as a release lever and an actuation drive lever. As a result, movement of the interacting components can result in a sudden disengagement upon overcoming frictional force therebetween, which can result in a “snapping” movement resulting in noise, particularly when the components re-engage one another. This phenomenon is most common during release and re-set of an actuator (motor) between home and deployed position. In some cases, to overcome high internal loads/friction, it is known to incorporate a motor having an output force well in excess of that needed during normal use so as to be able to ensure the door can be opened in an increased seal load and/or ice build-up condition. The need to provide the motor having an increased output force well in excess of that needed during normal use, although generally suitable for its intended use, comes with an increased cost, increased size, increased weight, and increased generation of noise.

Thus, there remains a need to develop alternative arrangements for latch mechanisms for use in vehicular door latches which optimize the ability to move a pawl from a ratchet holding position to a ratchet releasing position under the power of a powered motor without generating undesirable noise.

### SUMMARY

This section provides a general summary of the disclosure, and is not intended to be a comprehensive and exhaustive listing of all of its features or its full scope.

It is an object of the present disclosure to provide a power latch assembly for motor vehicle closure applications that overcomes at least those drawbacks discussed above associated with known power latch assemblies.

It is another object of the present disclosure to provide a power latch assembly for motor vehicle closure applications that generates minimal noise in use.

In accordance with the above objects, one aspect of the disclosure provides a power latch assembly for a closure panel of a motor vehicle. The power latch assembly includes a ratchet configured for movement between a striker capture position and a striker release position and being biased toward the striker release position. The power latch assembly further includes a pawl configured for movement between a ratchet holding position, whereat the pawl maintains the ratchet in the striker capture position, and a ratchet releasing position, whereat the pawl releases the ratchet for movement of the ratchet to the striker release position. The power latch assembly further includes a power actuator configured to drive a worm gear, with a power release gear configured to be driven about a power release gear axis in response to the worm gear being driven, and with power release gear having a rib. The power latch assembly further includes a spring coupled to the power release gear for conjoint movement with the power release gear, and a first lever coupled to the power release gear for pivotal movement relative to the power release gear, and a second lever. The spring biases the first lever to a rest position in spaced relation from the rib. Actuation of the power actuator in a first direction causes the worm gear to operably drive the power release gear about the power release gear axis from a home position to a deployed position, whereupon the first lever is driven into engagement with the second lever and deflected against the bias of the spring from the rest position into engagement with the rib, whereupon the rib drives the first lever to move the pawl from the ratchet holding position to the ratchet releasing position.

In accordance with another aspect of the disclosure, the first lever is supported for pivotal movement about a first lever axis relative to the power release gear, with the first lever axis being spaced from the power release gear axis.

In accordance with another aspect of the disclosure, the first lever axis is defined by a pin extending from the power release gear.

In accordance with another aspect of the disclosure, the first lever has a hub disposed about the pin for relative rotation therewith.

In accordance with another aspect of the disclosure, the first lever has a first lever arm extending from the hub and a second lever arm extending from the hub, and the spring has a first leg biased into engagement with the first lever arm and a second leg biased into engagement with the second lever arm.

In accordance with another aspect of the disclosure, the first leg and the second leg extend from an intermediate portion of the spring, with the intermediate portion being disposed about a drive lug extending from the power release gear such that the spring is driven conjointly with the power release gear.

In accordance with another aspect of the disclosure, the spring is disposed about the hub.

In accordance with another aspect of the disclosure, the first leg and the second leg deflect in response to the first lever engaging the second lever, thereby allowing the rib to be moved into forcible engagement with the first lever.

In accordance with another aspect of the disclosure, the first lever is driven past and out from engagement with the second lever when the power release gear reaches the deployed position, whereupon the first lever returns to the rest position, under the bias imparted by the spring, in spaced relation from said rib.

In accordance with another aspect of the disclosure, upon the power release gear reaching the deployed position, actuation of the power actuator in a second direction opposite the first direction causes the worm gear to operably drive the power release gear about the power release gear axis from the deployed position to the home position, whereupon the first lever is driven into engagement with the second lever and deflected against the bias of the spring from the rest position away from the rib, wherein the first lever is driven past and out from engagement with the second lever when the power release gear reaches the home position, whereupon the first lever returns to the rest position, under the bias imparted by the spring, in spaced relation from the rib.

In accordance with another aspect of the disclosure, the second lever is fixed to the pawl.

In accordance with another aspect of the disclosure, the spring has an intermediate portion fixed for conjoint movement with the power release gear, a first leg extending from the intermediate portion and a second leg extending from the intermediate portion, the first leg being spaced from the second leg and the first and second legs being fixed for conjoint movement with the first lever.

In accordance with another aspect of the disclosure, the first leg and the second leg deflect relative to the intermediate portion in response to the first lever engaging the second lever.

In accordance with another aspect of the disclosure, the power release gear has a drive lug configured in driving engagement with the intermediate portion of the spring.

In accordance with another aspect of the disclosure, a power latch assembly for a closure panel includes a ratchet configured for movement between a striker capture position and a striker release position and being biased toward the striker release position. The power latch assembly further includes a pawl configured for movement between a ratchet holding position, whereat the pawl maintains the ratchet in the striker capture position, and a ratchet releasing position, whereat the pawl releases the ratchet for movement of the ratchet to the striker release position. The power latch assembly further includes a power actuator configured to drive a worm gear about a worm gear axis, with a power release gear configured to be driven about a power release gear axis in response to the worm gear being driven about the worm gear axis, and with the power release gear having a rib. A spring is coupled to the power release gear for conjoint movement with the power release gear. A first lever is coupled to the power release gear for pivotal movement relative to the power release gear. The spring imparts a bias on the first lever to bias the first lever to a rest position in spaced relation from the rib of the power release gear. The power latch assembly further includes a second lever, wherein actuation of the power actuator in a first direction causes the worm gear to operably drive the power release gear about the power release gear axis from a home position toward a deployed position, whereupon the first lever is driven over a first arc out of engagement from the second lever, whereat the first lever remains spaced from the rib. Continued actuation of the power actuator in the first direction to continue operably driving the power release gear toward the deployed position brings the first lever into engagement with the second lever, whereupon the first lever is driven over a second arc. As first lever is driven over the second arc, first lever is deflected against the bias of the spring by the second lever to cause the rib fixed to power release gear to engage the first lever and urge the first lever over the second arc to move the second lever and cause the pawl to move from the ratchet holding position to the ratchet releasing position. Continued actuation of the power actuator in the first direction to continue operably driving the power release gear toward the deployed position drives first lever past and out from engagement with the second lever and over a third arc until the power release gear reaches the deployed position, whereat the first lever returns to the rest position, under the bias imparted by the spring, in spaced relation from the rib.

In accordance with another aspect of the disclosure, the first lever is supported for pivotal movement about a pin extending from the power release gear, with the pin being spaced from the power release gear axis.

In accordance with another aspect of the disclosure, the first lever has a hub, a first lever arm, and a second lever arm spaced from the first lever arm, and the spring has an intermediate portion, a first leg, and a second leg. The hub is disposed about the pin. The intermediate portion of the spring is disposed about a drive lug extending from the power release gear. The first leg of the spring extends away from the intermediate portion into engagement with the first lever arm of the first lever and the second leg of the spring extends away from the intermediate portion into engagement with the second lever arm of the first lever.

In accordance with another aspect of the disclosure, the first leg and the second leg of the spring deflect during movement of the first lever over the second arc.

In accordance with another aspect of the disclosure, upon the power release gear reaching the deployed position, actuation of the power actuator in a second direction opposite the first direction causes the worm gear to operably drive the power release gear about the power release gear axis from the deployed position to the home position, whereupon the first lever is driven over the third arc back into engagement with the second lever, and then over the second arc, whereat the first lever is deflected against the bias of the spring from the rest position away from the rib, wherein the first lever is driven past and out from engagement with the second lever and over the first arc, whereupon the first lever returns to the rest position, under the bias imparted by the spring, in spaced relation from said rib, until the power release gear reaches the home position.

In accordance with another aspect of the disclosure, a method of releasing a power latch assembly of a closure panel of a motor vehicle is provided. The power latch assembly having a ratchet configured for movement between a striker capture position and a striker release position and a pawl configured for movement between a ratchet holding position, whereat the pawl maintains the ratchet in the striker capture position, and a ratchet releasing position, whereat the pawl releases the ratchet for movement of the ratchet to the striker release position. The method includes actuating a power actuator to move in a first direction to operably drive a power release gear about a power release gear axis from a home position toward a deployed position and causing a first lever, pivotably coupled to the power release gear, to be driven over a first arc out of engagement from a second lever, coupled to the pawl, while being held in a rest position, out of engagement with a rib fixed to the power release gear, by a spring. Further, continuing movement of the power actuator in the first direction to move the first lever over a second arc in engagement with the second lever, whereat the first lever is deflected against the bias of the spring under a force imparted by the second lever to bring the rib fixed to the power release gear into engagement with the first lever to urge the first lever over the second arc, thereby pivoting the second lever via the first lever and causing the pawl to move from the ratchet holding position to the ratchet releasing position. Further yet, continuing movement of the power actuator in the first direction and moving the power release gear to the deployed position to move the first lever over a third arc spaced from the second lever, whereat the first lever is returned to the rest position under the bias imparted by the spring.

In accordance with another aspect of the disclosure, the method further includes a reset operation, with the reset operation including, after the power release gear reaches the deployed position, actuating the power actuator in a second direction, opposite the first direction, and returning the power release gear to the home position without causing the first lever to contact the rib.

In accordance with another aspect, there is provided a power release gear assembly for a latch assembly having a pawl and a ratchet, the power release gear assembly having a gear configured for rotation by a motor in a first direction and in an opposite direction, an actuation feature supported on the gear for moving the pawl out of engagement with the ratchet, the actuation feature is moveable away from a home position when the gear is rotated in the first direction to move the pawl out of engagement with the ratchet, and the actuation feature is moveable away.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 is a partial perspective view of a motor vehicle having a side door equipped with a power latch assembly embodying the teachings of the present disclosure;

FIG. 2A is a perspective view of a power latch assembly embodying the teachings of the present disclosure shown with a ratchet in a striker capture position;

FIG. 2B is another perspective view of the power latch assembly of FIG. 2A with the ratchet omitted for simplification of the view only;

FIG. 3 is an enlarged, partial plan view of a power release gear and noise reduction mechanism of the power latch assembly of FIGS. 2A and 2B illustrating a power release gear in a home position;

FIGS. 4A through 4E illustrate a release movement progression of the power release gear from the home position to a deployed position and corresponding movement of the noise reduction mechanism; and

FIGS. 5A through 5C illustrate a reset movement progression of the power release gear from the deployed position back to the home position and corresponding movement of the noise reduction mechanism.

Corresponding reference numerals are used throughout all of the drawings to indicate corresponding parts.

### DETAILED DESCRIPTION OF EXAMPLE EMBODIMENTS

One or more example embodiments of a powered latch assembly of the type well-suited for use in motor vehicle closure systems will now be described with reference to the accompany drawings. However, these example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by a skilled artisan.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

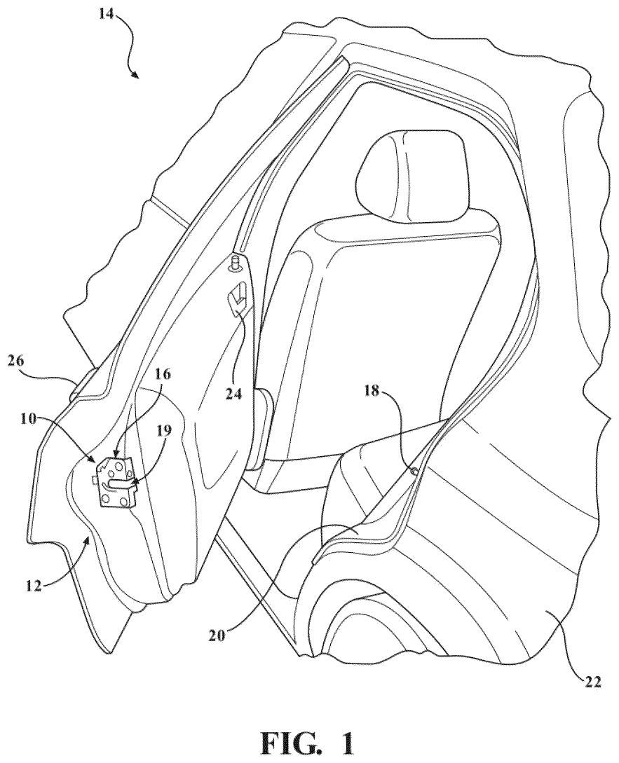

Referring initially to FIG. 1, a non-limiting example of a power latch assembly is shown, referred to hereafter simply as latch assembly 10, installed in a closure panel, such as, by way of example and without limitation, a door, shown as a passenger side swing door 12 of a motor vehicle 14. Latch assembly 10 includes a latch mechanism 16 having a noise reduction arrangement, also referred to as noise reduction mechanism 11 constructed in accordance with an aspect of the disclosure, with latch mechanism being configured to releasably latch and hold a striker 18 mounted to a sill portion 20 of a vehicle body 22 when swing door 12 is closed. Latch assembly 10 can be selectively actuated via an inside door handle 24, an outside door handle 26, and a key fob. As will be detailed, latch assembly 10 is configured to be power-operated via selective actuation of a power release actuator, also referred to as power actuator, such as an electric motor, and referred to hereafter as motor 30. For reasons discussed hereafter, motor 30 is able to be minimized in size, weight and power output, thereby enhancing the flexibility of design of the closure panel, while also reducing the cost associated therewith, and reducing generation of noise during operation of latch assembly 10.

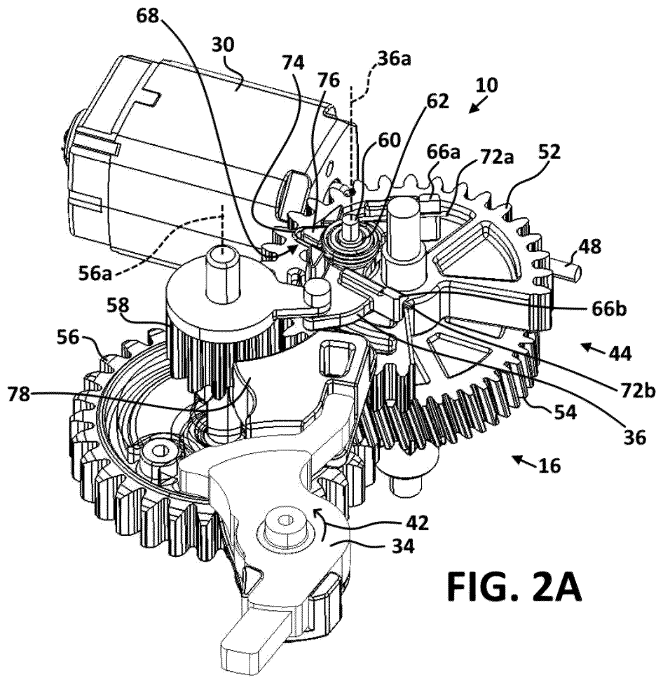

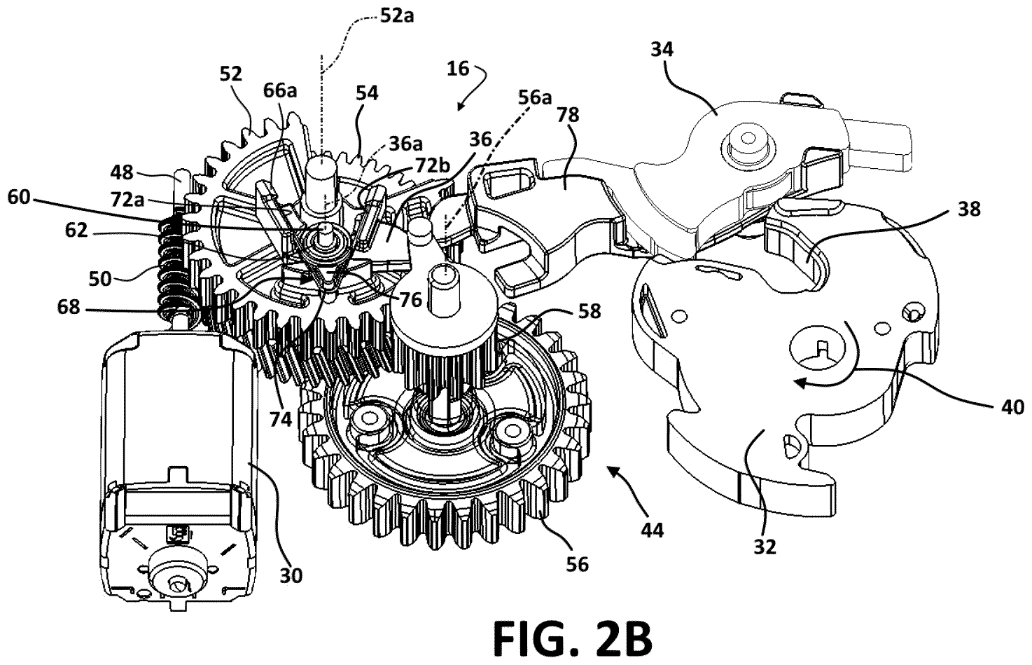

Referring to FIG. 2, shown is a non-limiting embodiment of latch assembly 10 and latch mechanism 16, which is contained in a housing (shown in FIG. 1), with some components being supported by a latch frame plate, wherein some components are removed for clarity purposes. Latch mechanism 16 includes a ratchet 32 and a pawl 34, and a first lever, also referred to as release lever 36. Ratchet 32 is movable between a striker capture position, whereat ratchet 32 retains striker 18 with a striker slot 38 of ratchet 32 and swing door 12 in closed position, and a striker release position, whereat ratchet 32 permits release of striker 18 from a fishmouth 19 (FIG. 1) provided by latch housing of latch assembly 10 to allow movement of swing door 12 to the open position. A ratchet biasing member 40 (shown schematically in FIG. 2A), such as a spring, is provided to normally bias ratchet 32 toward its striker release position. Pawl 34 is movable between a ratchet holding position, whereat pawl 34 holds ratchet 32 in its striker capture position, and a ratchet releasing position whereat pawl 34 permits ratchet 32 to move to its striker release position. A pawl biasing member 42 (shown schematically in FIG. 2A), such as a suitable spring, is provided to normally bias pawl 34 toward its ratchet holding position.

When desired to move pawl 34 from the ratchet holding positon to the ratchet releasing position during normal use conditions, such as when a person approaches motor vehicle 14 with electronic key fob and actuates the outside door handle 26, for example, sensing both the presence of key fob and that outside door handle 26 has been actuated (e.g. via electronic communication between an electronic switch (wherein inside door handle 24 also is actuatable via an electronic switch), such as discussed in co-owned U.S. Patent Publication No. 2023/0034544 to Mozola under U.S. patent application Ser. No. 17/868,289, filed Jul. 19, 2022, the entire disclosure of which being incorporated herein by way of reference, and a latch electronic control unit (ECU) that at least partially controls the operation of latch assembly 10. In turn, latch ECU actuates power release motor 30 to cause a gear reduction, also referred to as gear train 44, to become actuated by rotating an output shaft 48 of the power actuator 30 in a first direction to release the latch mechanism 16 and shift latch assembly 10 into an unlatched operating state so as to facilitate subsequent opening of vehicle swing door 12. Power release motor 30 can be alternatively activated as part of a proximity sensor based entry feature (radar based proximity detection for example), for example when a person approaches vehicle 14 with electronic key fob and actuates a proximity sensor, such as a capacitive sensor, or other touch/touchless based sensor (based on a recognition of the proximity of an object, such as the touch/swipe/hover/gesture or a hand or finger), (e.g. via communication between the proximity sensor and latch ECU that at least partially controls the operation of latch assembly 10). In turn, if detecting a normal use condition, such as the presence of electronic key fob, by way of example and without limitation, latch ECU actuates power release motor 30 to rotate the output shaft 48 in the first direction to release the latch mechanism 16 and shift latch assembly 10 into an unlatched operating state so as to facilitate subsequent opening of vehicle door 12, as discussed above.

During operation, upon motor 30 being energized, also referred to as activated, output shaft 48 is rotated in the first direction to rotate drive gear, also referred to as worm gear or worm 50, thereby causing a power release gear 52 to be rotated about a power release gear axis 52a from a home position to a deployed position in response to said worm 50 being driven, with gear train 44 shown transmitting an increased torque via the gear reduction between worm 50 and power release gear 52. Gear train 44 is shown, by way of example and without limitation, as including a first driven gear, shown as a first spur gear 54 arranged in meshed engagement with worm 50, with first spur gear 54 being supported for rotation about power release gear axis 52a. A first pinion gear (hidden below first spur gear 54) is fixed for conjoint rotation with first spur gear 54 about the power release gear axis 52a, with first pinion gear being arranged in meshed engagement with a second driven gear, shown as a second spur gear 56. Accordingly, power release gear 52, first spur gear 54, and first pinion gear are coaxially aligned with one another. Second spur gear 56 is supported for rotation about a second spur gear axis 56a. Second spur gear axis 56a is spaced from and generally parallel to power release gear axis 52a. A second pinion gear 58 is fixed for conjoint rotation with second spur gear 56 about the second spur gear axis 56a, with second pinion gear 58 being arranged in meshed engagement with power release gear 52. Accordingly, worm 50 is operably coupled to power release gear 52 via gear train 44, such that upon worm 50 being driven in rotation by motor 30, power release gear 52 is concurrently driven in rotation by intervening gear train 44. Upon power release gear 52 being driven to the deployed position, motor 30 is reversed in direction of rotation, thereby causing output shaft 48 to be rotated in a second direction opposite the first direction to rotate worm 50 in an opposite direction to that of release, thereby causing a power release gear 52 to be rotated about power release gear axis 52a from the deployed position back to the home position.

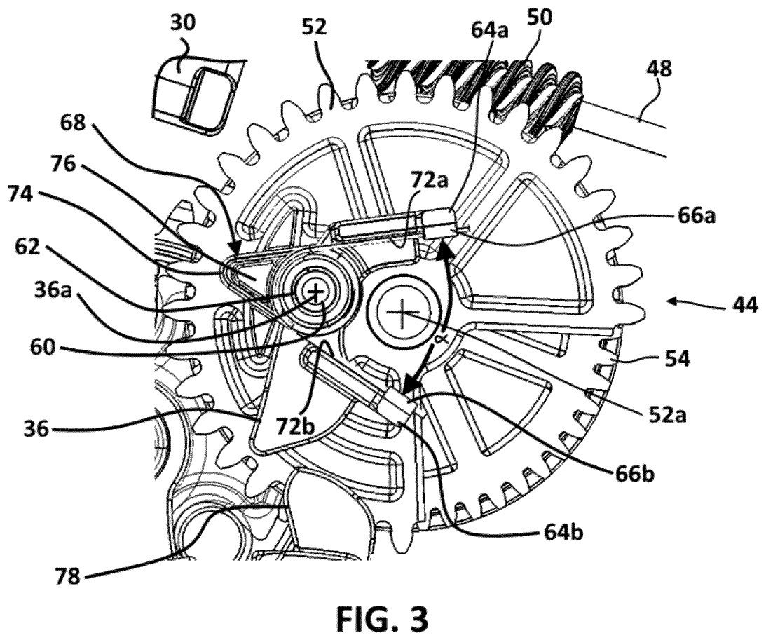

First lever 36 is coupled to the power release gear 52 for pivotal movement about a first lever axis 36a relative to power release gear 52, wherein the first lever axis 36a is spaced from the power release gear axis 52a, with first lever axis 36a shown being generally parallel to power release gear axis 52a. First lever axis 36a is defined by a pin 60 extending laterally outward from the power release gear 52, wherein pin 60 is fixed to power release gear 52 and can be formed as a monolithic piece of material therewith, or formed as a separate piece of material and subsequently fixed thereto, as desired. First lever 36 has a central body portion, referred to hereafter as hub 62, with hub 62 being configured to be disposed on and about pin 60 for relative pivotal rotation about pin 60. First lever 36 has a first lever arm 64a extending from the hub 62 and a second lever arm 64b extending from the hub 62, wherein the first and second lever arms 64a, 64b (only identified in FIG. 3 to avoid cluttering other FIGS.) are spaced from one another, and shown as diverging away from hub 62 to free ends, also referred to as terminal ends. In the non-limiting embodiment illustrated, the first and second arms 64a, 64b diverge from the hub 62 having an inclusive angle, also referred to as interior angle α (FIG. 3) between about 30-75 degrees, and illustrated as about 45 degrees, by way of example and without limitation. The first and second arms 64a, 64b each have a spring retention member, shown as respective spring tabs, also referred to as spring clips 66a, 66b, configured for snapping, locking receipt of portions of a biasing member, shown as a spring 68 therein. As discussed in further detail below, spring 68 imparts a bias on first lever 36 to position first lever 36 in a rest position, absent having an external bias imparted thereon, as discussed further below, in spaced relation from a protrusion, also referred to as rib 70 extending outwardly in fixed relation from power release gear 52.

Spring 68 has a first leg 72a biased into engagement with the first lever arm 64a and fixed thereto via spring clip 66a and a second leg 72b biased into engagement with the second lever arm 64b and fixed thereto via spring clip 66b. Accordingly, first and second legs 72a, 72b are fixed for conjoint movement with first lever 36. The first leg 72a and the second leg 72b extend from an intermediate portion 74 of spring 68. The intermediate portion 74 is disposed about a drive lug 76 extending in fixed relation from the power release gear 52. Drive lug 76 can be formed as a monolithic piece of material with power release gear 52, or formed as a separate piece of material and subsequently fixed thereto, as desired. Drive lug 76 is disposed within intermediate portion 74 in close fitting relation, such that any movement of drive lug 76 causes concurrent movement of spring 68 therewith. Accordingly, intermediate portion 74 is fixed for conjoint movement with power release gear 52. In the non-limiting embodiment illustrated, drive lug 76 is captured in a line-to-line or close, snug fit within a pocket defined between hub 62 and intermediate portion 74. Spring 68 can further be disposed about hub 62, such that the first and second legs 72a, 72b can be wrapped about hub 62. First and second legs 72a, 72b are shown extending away from one side of hub 62 to their respective terminal ends, which are fixed within respective spring clips 66a, 66b, while intermediate portion 74 extends away from an opposite side of hub 62 about drive lug 76.

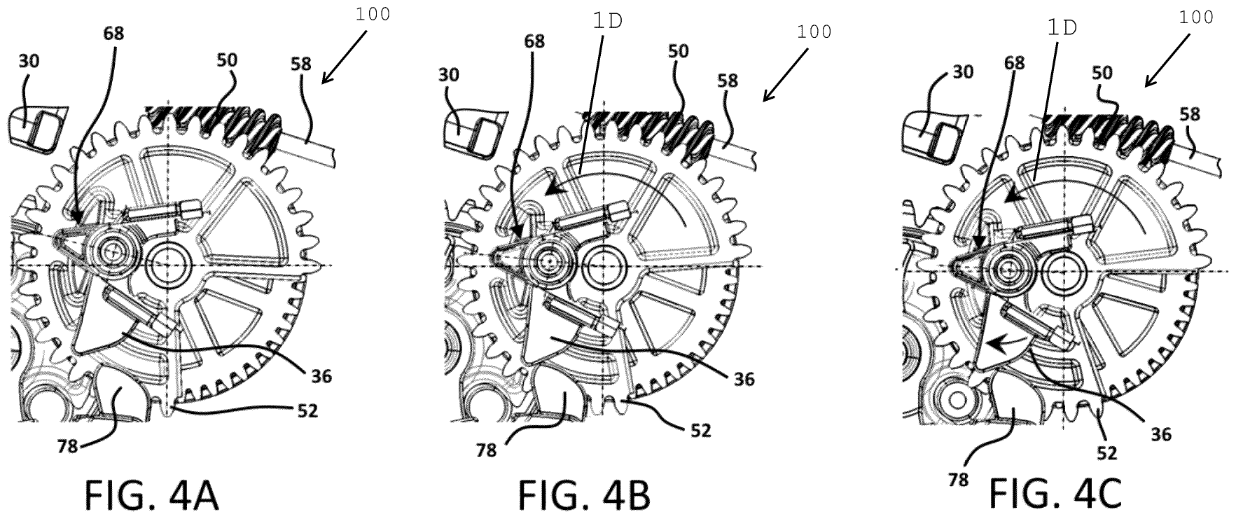

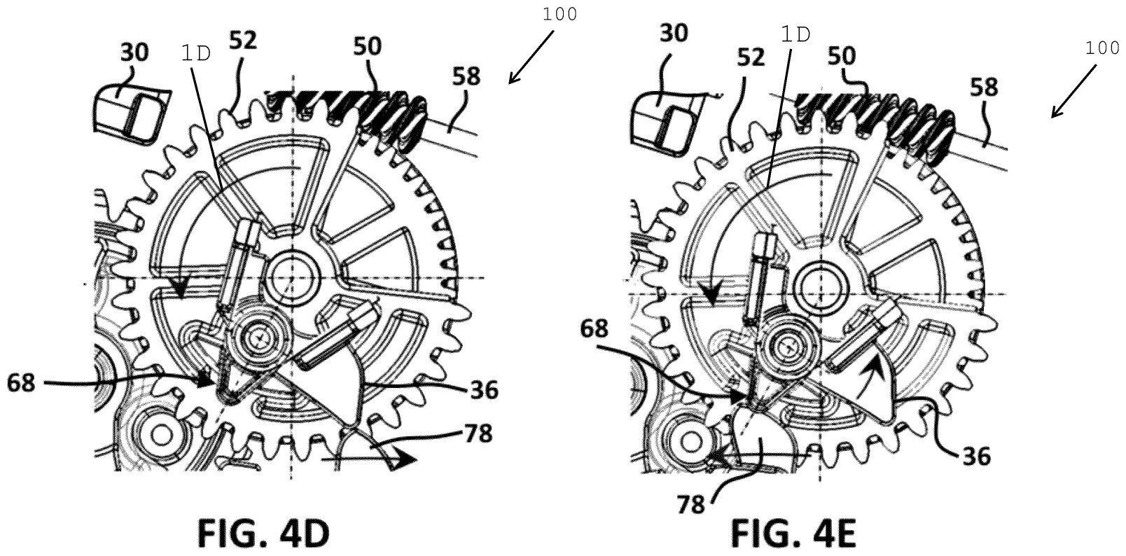

In more detail, as power actuator 30 is driven in first direction to cause worm 50 to operably drive power release gear 52 from the home position toward the deployed position, first lever 36 is driven over a first arc (FIGS. 4A-4B) out of engagement from a second lever 78, whereat the first lever 36 remains spaced from the rib 70. Then, continued movement of power release gear 52 toward the deployed position brings first lever 36 into engagement with second lever 78, whereupon first lever 36 is driven over a second arc (FIGS. 4C-4D), whereat first lever 36 is deflected against the bias to overcome bias of spring 68 via impact with second lever 78, thereby causing rib 70 to engage first lever 36 (FIG. 4C) and forcibly urge first lever 36 over the second arc, as shown in FIGS. 4C-4D, to move second lever 78, which is operably or directly coupled/connected to pawl 34, thereby causing pawl 34 to move from the ratchet holding position to the ratchet releasing position. While first lever 36 is illustratively shown as moving second lever 78, first lever 36 may be operatively coupled to the pawl 34 in other manners, such as in direct coupling or contact with pawl 34 as but one non-limiting example. As first lever 36 is forcibly urged by rib 70 to traverse the second arc, first leg 72a and second leg 72b deflect (FIG. 4C) in response to first lever 36 engaging second lever 78. Then, continued movement of power release gear 52 toward the deployed position causes first lever 36 to be driven past and out from engagement with second lever 78 and over a third arc (FIGS. 4D-4E) until power release gear 52 reaches the deployed position, whereat the first lever 36 returns to the rest position, under the bias imparted by spring 68, in spaced relation from rib 70.

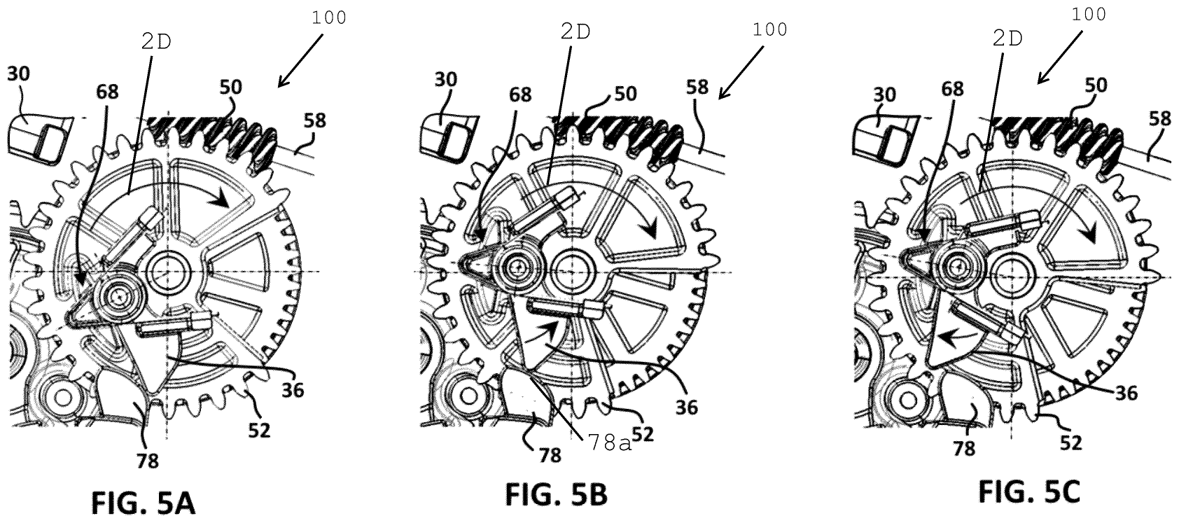

During a reset operation, as shown in FIGS. 5A-50, after power release gear 52 reaches the deployed position, actuation of power actuator 30 in a second direction, opposite the first direction utilized to move power release gear 52 from the home position to the deployed position, causes worm gear 50 to operably drive power release gear 52 about power release gear axis 52a from the deployed position back to the home position. Initial movement of power release gear 52 from the deployed position toward the home position causes first lever 36 to be driven over the third arc, whereat first lever 36 is out of engagement with second lever 78, back into initial engagement with second lever 78, and then over the second arc, whereat first lever 36 is deflected against the bias of spring 68 from the rest position, whereat first and second legs 72a, 72b are deflected (FIG. 5B), away from the rib 70. Then, continued movement of power release gear 52 toward the home position causes first lever 36 to be driven past and out from engagement with second lever 78 and over the first arc, whereupon first lever 36 is returned to the rest position under the bias imparted by spring 68, in spaced relation from rib 70, until power release gear reaches the home position (FIG. 5C). Accordingly, during the reset operation (FIGS. 5A-5C), the first lever 36 never makes contact with rib 70, thereby negating a potential source of noise generation of latch assembly 10.

In accordance with another aspect of disclosure, a method of releasing a power latch assembly 10 of a closure panel 12 of a motor vehicle 14 is provided. The method includes: actuating a power actuator to move in a first direction to operably drive a power release gear 52 about a power release gear axis 52a from a home position (FIG. 4A) toward a deployed position (FIG. 4E) and causing a first lever 36, pivotably coupled to the power release gear 52, to be driven over a first arc (FIGS. 4A-4B) out of engagement from a second lever 78 coupled (directly or indirectly, also referred to as operably) to the pawl 34 while being held in a rest position, out of engagement with a rib 70 fixed to the power release gear 52, by a spring 68. Further, continuing movement of the power actuator 30 in the first direction to move the first lever 36 over a second arc (FIGS. 4C-4D) in engagement with the second lever 78, whereat the first lever 36 is deflected against the bias of the spring 68 under a force imparted by the second lever 78 to bring the rib 70 fixed to the power release gear 52 into engagement with the first lever 36 to urge the first lever 36 over the second arc, thereby pivoting the second lever 78 via the first lever 36 and causing the pawl 34 to move from the ratchet holding position to the ratchet releasing position. Then, continuing movement of the power actuator 30 in the first direction to move the power release gear 52 to the deployed position and move the first lever 36 over a third arc (FIGS. 4D-4E) spaced from the second lever 78, whereat the first lever 36 is returned to the rest position under the bias imparted by the spring 68.

In accordance with another aspect of disclosure, the method further includes a reset operation, including after the power release gear 52 reaches the deployed position, actuating the power actuator 30 in a second direction opposite the first direction and returning the power release gear 52 to the home position without causing the first lever 36 to contact the rib 70. In further detail, the reset operation includes causing the worm gear 50 to operably drive the power release gear 52 about the power release gear axis 52a from the deployed position to the home position, whereupon the first lever 36 is caused to be driven over the third arc back into engagement with the second lever 78 and then over the second arc, whereat the first lever is caused to be deflected against the bias of the spring 68 from the rest position away from the rib 70, wherein the first lever is caused to be driven past and out from engagement with the second lever 78 and over the first arc, whereupon the first lever 36 returns to its rest position under the bias imparted by the spring 68, in continued spaced relation from the rib 70, until the power release gear 52 reaches its home position. Accordingly, during the reset operation, the first lever 36 never contacts rib 70, thereby avoiding any generation of noise which could otherwise result from contact between the first lever 36 and rib 70.

Referring back to FIG. 4A to 5C, a power release gear assembly 100 for the latch assembly 10 has the power release gear 52 configured for rotation by the motor 30 in a first direction 1D (see FIG. 4B to FIG. 4E) away from a home position shown in FIG. 4A to a fully releasing position (see FIG. 4E), and is rotatable in a second opposite direction 2D away from the fully releasing position (see FIG. 4E) back to the home position (see FIG. 4A). Power release gear 52 is illustrated as rotated via gear train 44, but in other configurations power release gear 52 may be rotated directly by gear worm 50. Supported on the power release gear 52 is an actuation feature e.g. the release lever 36. For example the actuation feature may be pivotally supported on the power release gear 52 about the pivot axis 36a. Illustratively the pivot axis 36a is not coaxial with the gear axis 52a, but in other configurations the pivot axis 36a and the gear axis 52a may be the same and co-axial. The actuation feature is moveable about its pivot axis 36a away from a home position (see FIG. 4A, 4E, 5C) in two directions. Actuation feature is illustratively biased in the home position by spring 68. Actuation feature is shown illustratively as a cam having a curved surface for sliding contact with the second lever 78 during a power releasing operation e.g. when gear 52 is rotated in direction 1D. When the power release gear 52 is rotated by the motor 30 (e.g. via the rotation of the worm gear 50) the actuation feature will move in tandem with the power release gear 52 in the first direction 1D until the actuation feature contacts the second lever 78. During contact of the actuation feature with the second lever 78 while moving in the first direction 1D, the actuation feature will move in a first direction away from its home position, against the bias of spring 68, until the actuation feature contacts the power release gear 52. The actuation feature may move in the first direction 1D away from its home position over a first range of travel until the actuation feature contacts the power release gear 52. Following the disengagement of the actuation feature from the second lever 78 the actuation feature will return to its home position under the bias force of the spring 68. When the power release gear 52 is rotated by the motor 30 now in a reset direction (e.g. via the rotation of the worm gear 50) the actuation feature will illustratively move in tandem with the power release gear 52 in the second direction 2D until the actuation feature contacts the second lever 78 during its return travel. During contact of the actuation feature with the second lever 78, now on a opposite side of the release lever 78 having a curved surface 78a, while moving in the second direction 2D, the actuation feature will move in a second direction away from its home position, against the bias of spring 68, over a second range of travel, which may be illustratively greater than the first range of travel; the maximum deflection travel of the actuation feature now moving in the second direction 2D away from its home position during contact with the curved surface 78a may not be limited by contact with a stop formed on the power release gear 54 so as to ensure the actuation feature is cammed over the release lever 78 to allow the actuation feature to move past the second lever 78 on the return of the power release gear 52 to its home position. Following the actuation feature moving past the second lever 78, the actuation feature will return to its home position under the bias force of the spring 68.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power latch assembly for a closure panel, comprising:
a ratchet configured for movement between a striker capture position and a striker release position and being biased toward said striker release position;
a pawl configured for movement between a ratchet holding position, whereat said pawl maintains said ratchet in said striker capture position, and a ratchet releasing position, whereat said pawl releases said ratchet for movement of said ratchet to said striker release position;
a power actuator configured to drive a worm gear;
a power release gear configured to be driven about a power release gear axis in response to said worm gear being driven, said power release gear having a rib;
a spring coupled to said power release gear for conjoint movement with said power release gear;
a first lever coupled to said power release gear for pivotal movement relative to said power release gear, said spring biasing said first lever to a rest position in spaced relation from said rib; and
a second lever,
wherein actuation of said power actuator in a first direction causes said worm gear to operably drive said power release gear about said power release gear axis from a home position to a deployed position, whereupon said first lever is driven into engagement with said second lever and deflected against the bias of said spring from said rest position into engagement with said rib, whereupon said rib drives said first lever to move said pawl from the ratchet holding position to the ratchet releasing position.

2. The power latch assembly of claim 1, wherein said first lever is supported for pivotal movement about a first lever axis relative to said power release gear, said first lever axis being spaced from said power release gear axis.

3. The power latch assembly of claim 2, wherein said first lever axis is defined by a pin extending from said power release gear.

4. The power latch assembly of claim 3, wherein said first lever has a hub disposed about said pin.

5. The power latch assembly of claim 4, wherein said first lever has a first lever arm extending from said hub and a second lever arm extending from said hub, and said spring has a first leg biased into engagement with said first lever arm and a second leg biased into engagement with said second lever arm.

6. The power latch assembly of claim 5, wherein said first leg and said second leg extend from an intermediate portion of said spring, said intermediate portion disposed about a drive lug extending from said power release gear.

7. The power latch assembly of claim 6, wherein said spring is disposed about said hub.

8. The power latch assembly of claim 5, wherein said first leg and said second leg deflect in response to said first lever engaging said second lever.

9. The power latch assembly of claim 1, wherein said first lever is driven past and out from engagement with said second lever when said power release gear reaches said deployed position, whereupon said first lever returns to the rest position, under the bias imparted by said spring, in spaced relation from said rib.

10. The power latch assembly of claim 9, wherein upon said power release gear reaching said deployed position, actuation of said power actuator in a second direction opposite said first direction causes said worm gear to operably drive said power release gear about said power release gear axis from the deployed position to the home position, whereupon said first lever is driven into engagement with said second lever and deflected against the bias of said spring from said rest position away from said rib, wherein said first lever is driven past and out from engagement with said second lever when said power release gear reaches said home position, whereupon said first lever returns to the rest position, under the bias imparted by said spring, in spaced relation from said rib.

11. The power latch assembly of claim 1, wherein the second lever is fixed to the pawl.

12. The power latch assembly of claim 1, wherein said spring has an intermediate portion fixed for conjoint movement with said power release gear, a first leg extending from said intermediate portion and a second leg extending from said intermediate portion, said first leg being spaced from said second leg and said first and second legs being fixed for conjoint movement with said first lever.

13. The power latch assembly of claim 11, wherein said first leg and said second leg deflect relative to said intermediate portion in response to said first lever engaging said second lever.

14. The power latch assembly of claim 11, wherein said power release gear has a drive lug configured in driving engagement with said intermediate portion of said spring.

15. A power latch assembly for a closure panel, comprising:
a ratchet configured for movement between a striker capture position and a striker release position and being biased toward said striker release position;
a pawl configured for movement between a ratchet holding position, whereat said pawl maintains said ratchet in said striker capture position, and a ratchet releasing position, whereat said pawl releases said ratchet for movement of said ratchet to said striker release position;
a power actuator configured to drive a worm gear about a worm gear axis;
a power release gear configured to be driven about a power release gear axis in response to said worm gear being driven about said worm gear axis, said power release gear having a rib;
a spring coupled to said power release gear for conjoint movement with said power release gear;
a first lever coupled to said power release gear for pivotal movement relative to said power release gear, said spring imparting a bias on said first lever to bias said first lever to a rest position in spaced relation from said rib; and
a second lever,
wherein actuation of said power actuator in a first direction causes said worm gear to operably drive said power release gear about said power release gear axis from a home position toward a deployed position, whereupon said first lever is driven over a first arc out of engagement from said second lever, whereat said first lever remains spaced from said rib, and into engagement with said second lever, whereupon said first lever is driven over a second arc, whereat said first lever is deflected against the bias of said spring by said second lever to cause said rib to engage said first lever and urge said first lever over said second arc to move said second lever and cause said pawl to move from the ratchet holding position to the ratchet releasing position, whereupon said first lever is driven past and out from engagement with said second lever and over a third arc until said power release gear reaches said deployed position, whereat said first lever returns to the rest position, under the bias imparted by said spring, in spaced relation from said rib.

16. The power latch assembly of claim 15, wherein said first lever is supported for pivotal movement about a pin extending from said power release gear, said pin being spaced from said power release gear axis.

17. The power latch assembly of claim 16, wherein said first lever has a hub, a first lever arm, and a second lever arm spaced from said first lever arm, and said spring has an intermediate portion, a first leg, and a second leg, said hub being disposed about said pin, said intermediate portion of said spring being disposed about a drive lug extending from said power release gear, said first leg of said spring extending away from said intermediate portion into engagement with said first lever arm of said first lever and said second leg of said spring extending away from said intermediate portion into engagement with said second lever arm of said first lever.

18. The power latch assembly of claim 17, wherein said first leg and said second leg of said spring deflect during movement of said first lever over said second arc.

19. The power latch assembly of claim 15, wherein after said power release gear reaches said deployed position, actuation of said power actuator in a second direction opposite said first direction causes said worm gear to operably drive said power release gear about said power release gear axis from the deployed position to the home position, whereupon said first lever is driven over said third arc back into engagement with said second lever and then over the second arc, whereat said first lever is deflected against the bias of said spring from said rest position away from said rib, wherein said first lever is driven past and out from engagement with said second lever and over said first arc, whereupon said first lever returns to the rest position under the bias imparted by said spring, in spaced relation from said rib, until said power release gear reaches said home position.

20. A power release gear assembly for a latch assembly having a pawl and a ratchet, comprising:
a gear configured for rotation by a motor in a first direction and in an opposite second direction;
an actuation feature supported on the gear for moving the pawl out of engagement with the ratchet, the actuation feature is moveable away from a home position when the gear is rotated in the first direction to move the pawl out of engagement with the ratchet, and the actuation feature is moveable away from the home position when the gear is rotated in the second direction.
